(19) United States
(12) Patent Application Publication
(10) Pub. No.: US 2008/0078083 A1
(43) Pub. Date: Apr. 3, 2008

(54) Drive pin system for a wind turbine structural tower

(76) Inventors: Tracy Livingston, Heber, UT (US); Todd Andersen, Heber City, UT (US); David Oliphant, Heber City, UT (US); Thomas Conroy, Heber City, UT (US)

Correspondence Address: GRANT R CLAYTON;CLAYTON HOWARTH & CANNON, PC, P O BOX 1909, SANDY, UT, 84091-1909, US

(21) Appl. No.: 11/906,758

(22) Filed: Oct. 2, 2007

Related U.S. Application Data
(60) Provisional application No. 60/848,857, filed on Oct. 2, 2006.

(51) Int. Cl. E04H 12/10; B27F 7/05

(52) U.S. Cl. 29/897.31

(57) ABSTRACT

A method and system for installing a drive pin in an interference hole created by joining a first structural member and second structural member of a wind turbine structural tower is disclosed.

### CROSS REFERENCE TO RELATED APPLICATIONS

This present application claims the benefit of U.S. Provisional Patent Application No. 60/848,857, entitled “Drive Pin System for a Wind Turbine Structural Tower,” filed Oct. 2, 2006, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### TECHNICAL FIELD

The present disclosure relates generally to wind turbines and structural towers, and more particularly, but not necessarily entirely, to equipment and methods used in assembling structural towers for wind turbines and for connecting two or more structural members in such structural towers.

### BACKGROUND

Wind turbines, as illustrated in FIG. 1, are an increasingly popular source of energy in the United States and Europe and in many other countries around the globe. In order to realize scale efficiencies in capturing energy from the wind, developers are erecting wind turbine farms having increasing numbers of wind turbines with larger turbines positioned at greater heights.

To mechanically erect such large structural towers drive pins, or A325 interference fit interrupted body bolts, were developed for creating a low maintenance connection between two or more structural members. Historically the method of using/inserting these drive pins was to manually drive or insert the pin into place using a large hammer, such as a sledge hammer or other device, and hitting the drive pin several times until the pin is positioned in its desired location. Not only does this method require heavy labor, but it is also difficult, if not impossible, to control and monitor the quality of the connected joint and pin.

For example, in lattice type wind turbine towers the connections are shear loaded. Lattice type wind turbine towers have on the order of 100 or more shear loaded structural connections where two or more structural elements are connected by use of a mechanical fastener. Traditionally the fastener used in these connections is a standard threaded bolt and nut of the appropriate size and strength. Use of standard bolts requires an oversize bolt hole to provide sufficient assembly clearance. FIGS. 2 and 3 illustrate the shear forces that are lattice type wind turbine towers experience at a connection of two or more structural members.

Unlike structural connections in building structures, which are subject primarily to static loading, connections in lattice wind turbine towers experience cyclic loading which in many cases is fully reversed. It will be appreciated that the term “fully reversed” means that the joint experiences cyclic loading where one full cycle takes the connection from a state of tension to a state of compression or vise-versa.

For connections that are subject to cyclic loading, especially when the loading is fully reversed, relative motion between the connected elements is a concern. This relative motion is possible because of the assembly tolerance between the fastener and the hole, as illustrated in FIG. 2. It will be appreciated that relative motion, or connection slippage (see FIG. 3), may cause the following problems: 1) Mechanical wear of connected elements; 2) Loosening of fasteners; and 3) Loss of structural integrity in structure.

The propagation of problem 2) has the effect of accelerating problems 1) and 3) until the point where a fastener actually falls out and the connection becomes completely ineffective and the connected element can no longer support any structural load.

Prior devices are thus characterized by several disadvantages that may be addressed by the present disclosure. To effectively utilize drive pins in turbine towers in the wind power industry, quality control in both the fabrication process and also in the installation process is required. Thus, in order to effectively utilize drive pins, Applicant has developed a method to use an interference fit drive pin providing quality control and monitoring in the installation process. The present disclosure minimizes, and in some aspects eliminates, the above-mentioned failures, and other problems, by utilizing the methods and structural features described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a perspective view of a structural tower having a wind turbine assembly mounted thereon;

FIG. 1A is a perspective view of a section of the structural tower of FIG. 1;

FIG. 2 is a cross-sectional view of an initial condition of a joint between two structural members connected using a fastener and nut and used in the structural tower;

FIG. 3 is a cross-sectional view of the joint illustrated in FIG. 2 in a slipped condition illustrating the shear forces traditionally experienced in lattice type structural towers;

FIG. 4 is a cross-sectional view of a joint similar to the joint illustrated in FIG. 2 and illustrating a length/diameter relationship, where the length is a clamped length of the structural member connection and the diameter is a fastener diameter;

FIG. 5 is a cross-sectional view of a shank of a drive pin fastener made in accordance with the principles of the present disclosure;

FIG. 6 is a cross-sectional view of two different shanks of two different drive pins each having a different number of knurls and made in accordance with the principles of the present disclosure;

FIG. 7 is a cross-sectional view of two different shanks of two different drive pins each having a different shape of knurls and made in accordance with the principles of the present disclosure;

FIG. 8 is a side view of a drive pin fastener made in accordance with the principles of the present disclosure;

FIG. 9 is a side view of two structural members joined together using the drive pins according to the principles of the present disclosure;

FIG. 10 is a side, cross-sectional view of a drive pin pulling system according to the principles of the present disclosure;

FIG. 10A is a side, cross-sectional view of a drive pin pulling system illustrating a chuck style interface rod according to the principles of the present disclosure; and

FIG. 11 is a side, cross-sectional view of a drive pin pushing system according to the principles of the present disclosure.

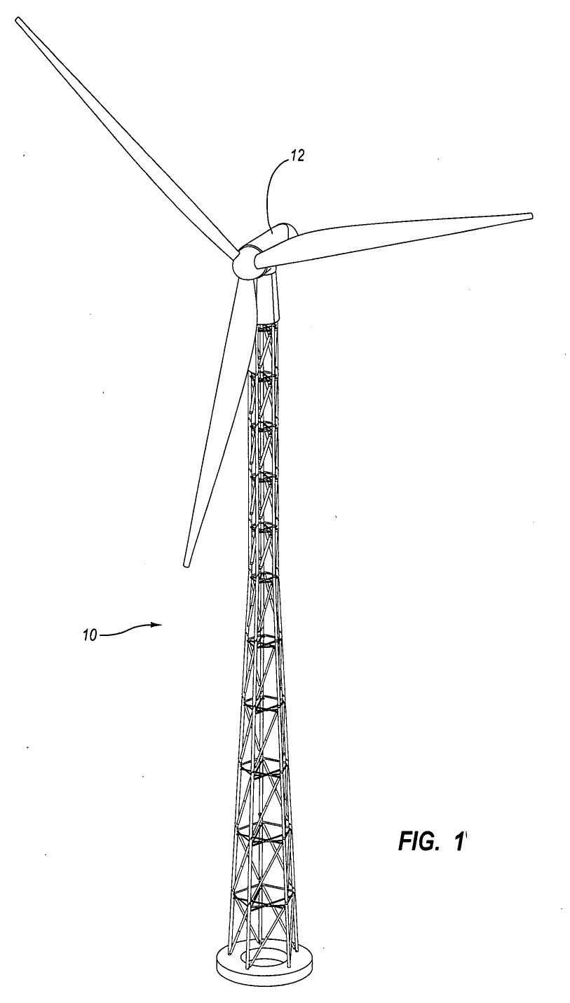

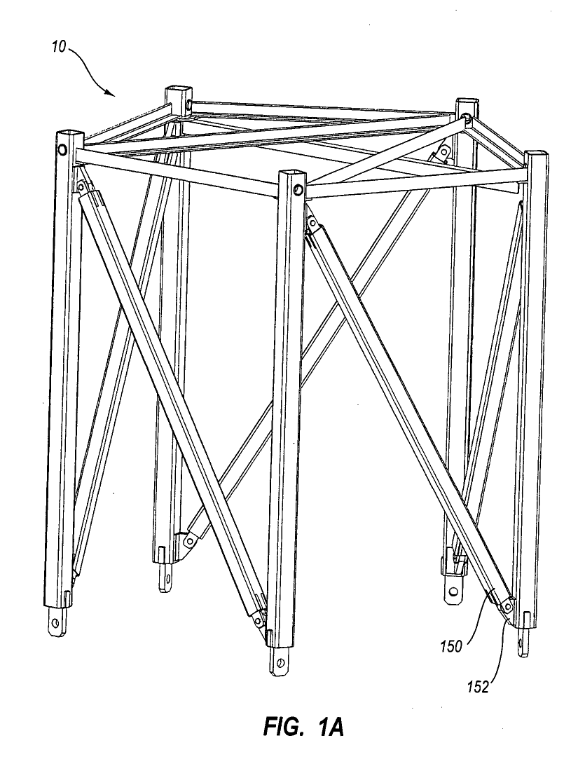

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Further details of the methods and components making up such structural towers for wind turbine applications are presented in commonly-owned and pending U.S. patent application Ser. No. 11/433,147, entitled “STRUCTURAL TOWER,” commonly-owned and pending U.S. Provisional Patent Application Ser. No. 60/899,492, filed Feb. 5, 2007, entitled “WIND TURBINE SYSTEMS WITH DAMPING MEMBERS,” commonly-owned and pending U.S. Provisional Patent Application Ser. No. 60/848,725, filed Oct. 2, 2006, entitled “LIFTING SYSTEM FOR WIND TURBINE AND STRUCTURAL TOWER,” commonly-owned and pending U.S. Provisional Patent Application Ser. No. 60/848,726, filed Oct. 2, 2006, entitled “CLADDING SYSTEM FOR A WIND TURBINE STRUCTURAL TOWER,” commonly-owned and pending U.S. patent application Ser. No. 11/649,033, filed Jan. 3, 2007, entitled “LIFTING SYSTEM AND APPARATUS FOR CONSTRUCTING WIND TURBINE TOWERS,” commonly-owned and pending U.S. Provisional Patent Application Ser. No. 60/848,857, filed Oct. 2, 2006, entitled “SYSTEM AND APPARATUS FOR CONSTRUCTING AND ENCLOSING WIND TURBINE TOWERS,” commonly-owned and pending U.S. Provisional Patent Application Ser. No. 60/899,470, filed Feb. 5, 2007, entitled “WIND TURBINE SYSTEMS WITH WIND TURBINE TOWER DAMPING MEMBERS,” commonly-owned and pending U.S. patent application Ser. No. ______ filed Oct. 2, 2007, entitled “SYSTEM AND APPARATUS FOR CONSTRUCTING AND ENCLOSING WIND TURBINE TOWERS,” commonly-owned and pending U.S. patent application Ser. No. ______ filed Oct. 2, 2007, entitled “EXPANSION PIN SYSTEM FOR A WIND TURBINE STRUCTURAL TOWER,” all of the disclosures of which are now incorporated herein in their entireties by this reference. The publications and other reference materials referred to herein to describe the background of the disclosure, and to provide additional detail regarding its practice, are hereby incorporated by reference herein in their entireties, with the following exception: In the event that any portion of said reference materials is inconsistent with this application, this application supercedes said reference materials. The reference materials discussed herein are provided solely for their disclosure prior to the filing date of the present application. Nothing herein is to be construed as a suggestion or admission that the inventors are not entitled to antedate such disclosure by virtue of prior disclosure, or to distinguish the present disclosure from the subject matter disclosed in the reference materials.

Before the present systems and methods for connecting at least two structural members together to install and erect a wind turbine structural tower are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present disclosure will be limited only by the appended claims and equivalents thereof.

In describing and claiming the present disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

Before the details of the present disclosure are discussed, the mechanics of shear loaded structural connections must be appreciated. The ability of a shear loaded connection using standard threaded fasteners to resist slippage is dependant on two primary factors. These factors are: (1) the coefficient of friction, μ, between connected elements; and (2) the preload, or clamping force, Fᵢ, in the fastener(s). The slip resistance, R, of the connection is proportional to the above factors according to the following relationship (Equation 1):
R∞μFᵢn
where n is the number of bolts in the joint.

In theory, if the slip resistance, R, of the connection is equal to or greater than the maximum shear load experienced by the connection then slippage will not occur. According to the proportionality shown in Equation 1, for a given shear load, P, and coefficient of friction, μ, the number of bolts and the amount or preload in those bolts can be chosen to provide sufficient slip resistance.

The weak link in proportionality is the bolt pretension, Fᵢ. Traditionally the preload in the bolts had been difficult to control and maintain. If, for example, the bolts in a connection are not tightened enough to give the proper preload, the slip resistance will be too low and slippage may occur in the connection during service. The onset of slippage has the effect of loosening the nut. Loosening of the nut has the effect of reducing the preload in the fastener even more, which can result in more slippage at lower load levels until the nut becomes so loose that nearly all the preload in lost. Even properly preloaded fasteners can experience loosening if the connection sees a load level that exceeds the slip resistance and the connection slips.

In either case mentioned above, loss of fastener preload due to nut loosening caused by connection slippage can be reduced by use of fasteners with a large length to diameter ratio L/D. FIG. 4 illustrates the concept of this ratio, where “L” is the clamped length of the connection and “D” is the diameter of the fastener.

Because a bolt may behave like a spring, when it is preloaded it may elastically stretch according to hooks law (Equation 2):
Fᵢ=k_{Δ}
where Fᵢ=bolt preload; k=bolt axial stiffness; and Δ=bolt stretch.

The bolt stiffness, k_{b}, can be related to the ratio L/D with the following equation (Equation 3):

$${k}_{b} = \frac{{A}_{b} E}{L} = \frac{π {D}^{2} E}{4 L} = [ \frac{π DE}{4} ] [ \frac{D}{L} ] = \frac{π DE}{4 r}$$

where r=L/D; E=Elastic modulus of bolt material; and A_{b}=Cross sectional area of bolt.

The compressive stiffness of the clamped material, kₘ, can also be related to the L/D ratio with the following expression:
kₘ=DEAe^{b(1/r)}
where A is a constant=0.78715; and b is a constant=0.62873.

Assuming that the fastener is sufficiently tight that the connected elements are in full contact with each other and the nut, the bolt stretch, Δ, can be related to nut rotation, 6, in degrees, with the following equation (Equation 4):

$$Δ = \frac{θ}{360 n} [ \frac{{R}_{k}}{1 + {R}_{k}} ]$$

$${R}_{k} = \frac{{k}_{m}}{{k}_{b}} = \frac{4 r A {ⅇ}^{b ( l / r )}}{π}$$

where n=threads per inch of fastener.

Combining Equations (2), (3), and (4) and taking the derivative with respect to θ yields the following relationship (Equation 5):

$$\frac{ⅆ {F}_{i}}{ⅆ θ} = \frac{π DE}{1440 rn} [ \frac{{R}_{k}}{1 + {R}_{k}} ]$$

Equation 5 represents the amount of bolt preload per degree of nut rotation.

A typical shear loaded bolted connection uses bolts in the range of about ½ inch to about 1 inch and has an L/D of about 2. A typical connection can lose between about four percent and about eight percent of its slip resistance for every one degree of nut loosening rotation.

As a potential solution to resolve the problem discussed herein, the present disclosure may increase L/D ratio. A reliable connection may be obtained if the L/D ratio is greater than or equal to about six. Most shear loaded connections consist of relatively thin connected elements. Therefore the only way to get an L/D ratio this large is with the use of additional spacers to facilitate the use of long bolts. Such a solution would only increase the reliability and maintainability of the bolt tension and does not directly eliminate the possibility of slippage.

Another potential solution is to eliminate the assembly tolerance between the bolt hole and the bolt by use of an interference fit during assembly. This solution does not rely on bolt preload to ensure connection effectiveness. In fact there may not be a need for any bolt preload because in the absence of the assembly tolerance, slippage cannot physically occur. Focusing on this second solution, it has been found that various methods of achieving an interference fit in a shear loaded connection in a wind turbine tower, which methods may include, but are not necessarily limited to, the grooved (or knurled) shank drive pin as discussed herein, which may be advantageous.

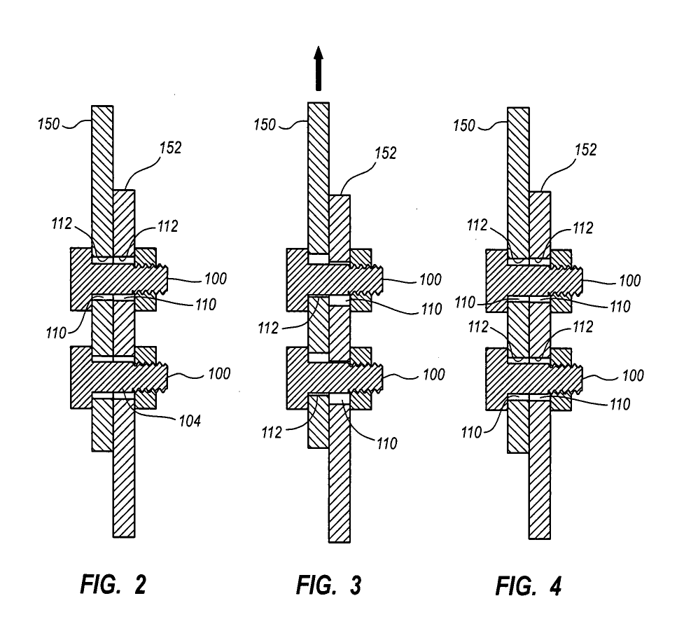

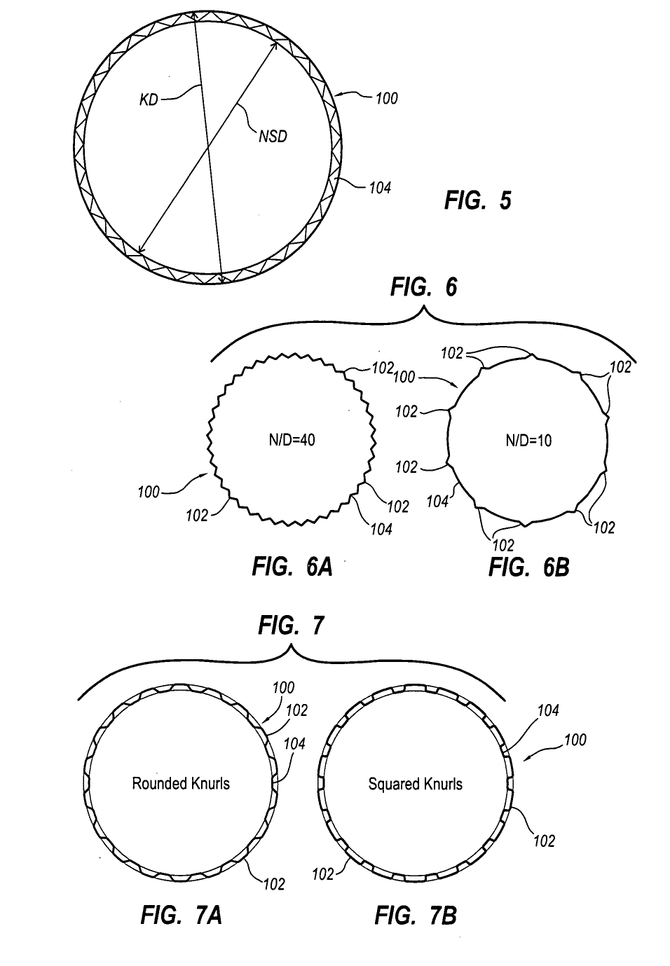

Referring now to FIGS. 5-8, several illustrative embodiments of a drive pin 100 that may be utilized by the present disclosure are illustrated. The drive pin 100 may join, secure or connect at least a first structural member 150 to a second structural member 152 (see FIG. 2) of a structural tower 10 to support a wind turbine 12 or other device. The joining, securing or connecting of the first structural member 150 to the second structural member 152 may occur through an interference fit between a sidewall 112 defining a hole 110 and a finite number of raised knurls 102 on a shank 104 of the pin 100.

For example, in FIG. 5 there is illustrated a cross section of the shank 104 of an exemplary embodiment of the pin 100. In order for the interference fit to function, a nominal shank diameter (the inner-most diameter of the shank without the knurls), as illustrated in FIG. 5 by the line labeled “NSD,” must be less than a diameter of the hole 110 into which the pin 100 may be inserted. A knurled diameter (the outer most diameter of the shank with the knurls), as illustrated in FIG. 5 by the line labeled “KD,” may be typically, but not necessarily limited to, about 0.01 inch to about 0.025 inch larger than the diameter of the hole 110. The ratio of the number of raised knurls 102, N, to the nominal shank diameter NSD, also designated herein as D, is typically between, but is not necessarily limited to, about 10 and 40. FIG. 6 compares shanks 104 with different N/D values.

For example, one embodiment of a shank N/D ratio may be about 40 (see FIG. 6A), while another embodiment of the shank's N/D ratio may be about 10 (see FIG. 6B). It will be appreciated that the N/D ratios or the number of knurls 102 that may be utilized by the present disclosure may vary somewhat without departing from the spirit or scope of the present disclosure and all ratios between 10 and 40 are meant to fall within the scope of the present disclosure.

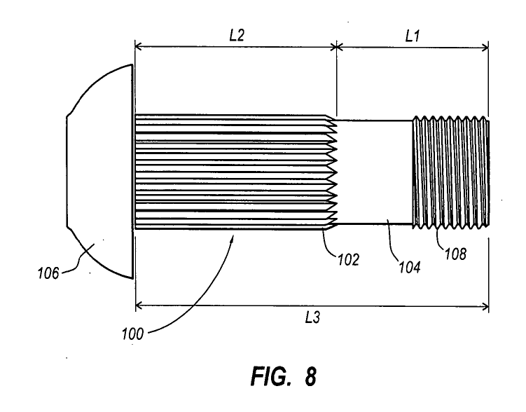

It will also be appreciated that the cross-sectional shape of the knurls 102 can take various shapes or forms, such as those illustrated in FIGS. 5-7. For example, exemplary shapes or forms may include, but are not necessarily limited to, the following: triangular (illustrated best in FIGS. 6A and 6B), rounded (illustrated best in FIG. 7A), or square (illustrated best in FIG. 7B). It will be appreciated that other geometric cross-sectional shapes of the knurls 102 may be utilized by the present disclosure without departing from the spirit or scope of the present disclosure.

Additionally, the pin 100 may include a head 106. The shape of the head 106 of the pin 100 may also take various shapes or forms including, but not necessarily limited to, rivet style (illustrated best in FIG. 8) and bolt style (not illustrated), for example a hex bolt, which is widely known in the industry, or other head shapes known or that may become known in the future. It will be appreciated that the pin 100 may be made from any suitable material without departing from the spirit or scope of the present disclosure. For example, the pin 100 may be manufactured from a metallic material of sufficient strength to withstand the applied load in both bearing and shear.

It will be appreciated that as the pin 100 is inserted into the hole 100, the knurls 102 may be deformed until the knurl diameter, KD, matches the diameter of the hole 110. The result may be a tightly formed interference fit that allows substantially no relative movement, or slippage, between the connected elements.

The pin 100 may comprise a first length (L1) that may be threaded and a second length (L2) that may be knurled, as illustrated in FIG. 8. The pin 100 may also include a fastener length (L3) that may include both the threaded and knurled lengths (see FIG. 8). It will be appreciated that the threads 108 may be used in conjunction with a nut (not illustrated), similar to a threaded bolt, to “draw” the pin 100 through the hole 110 when joining at least two structural members 150, 152. The pin 100 may also have a fastener length (L3) that may be entirely knurled 102 without threads 108 or entirely threaded 108 without knurls 102, without departing from the spirit or scope of the present disclosure. In one exemplary embodiment that may comprise knurls 102 entirely, the pin 100 may be required to be “driven” into the hole 110. Of course, a pin 100 having only threads 108 or a combination of threads 108 and knurls 102 may be completely “driven” into place or completely “drawn” into place using a nut to tighten the drive pin 100 or a combination of both.

Thus, the pin 100 may be retained in the hole 110 by the interference force between the pin 100, e.g., the knurls 102, and the sidewall 112 defining the hole 110. In other words, as the knurls 102 of the pin 100 enter into the hole 110, the knurls 102 may contact the sidewall 112 of the hole 110 and bite into the sidewall 112 forming an interference fit between the knurls 102 of the pin 100 and the sidewall 112 of the hole 110.

Additional retaining can be achieved by use of a nut, for a threaded pin, or a retaining device such as a snap ring or cotter pin for a drive pin 100 with no threads in the fastener length. If a threaded drive pin 100 is used in conjunction with a nut, the nut need only be snug tight as preload on the fastener is not required for proper function of the connection.

It will be appreciated that one example of the drive pin 100 for use in a space frame or lattice wind turbine tower is as follows. A pin 100 may be of sufficient length to extend through at least two or more connecting or structural members or elements 150, 152. The pin 100 may include knurls 102 having a triangular cross-sectional form and may have an N/D ratio of 30. The knurl diameter, KD, may be about 0.015 inch larger than the sidewall defining the diameter of the hole 110. The pin 100 may be made from steel and may include a fastener length having threads 108. The pin 100 may be “drawn” through the connecting or structural members or elements 150, 152 by tightening a nut onto the threads 108. It will be appreciated that the head 106 may be a rivet style.

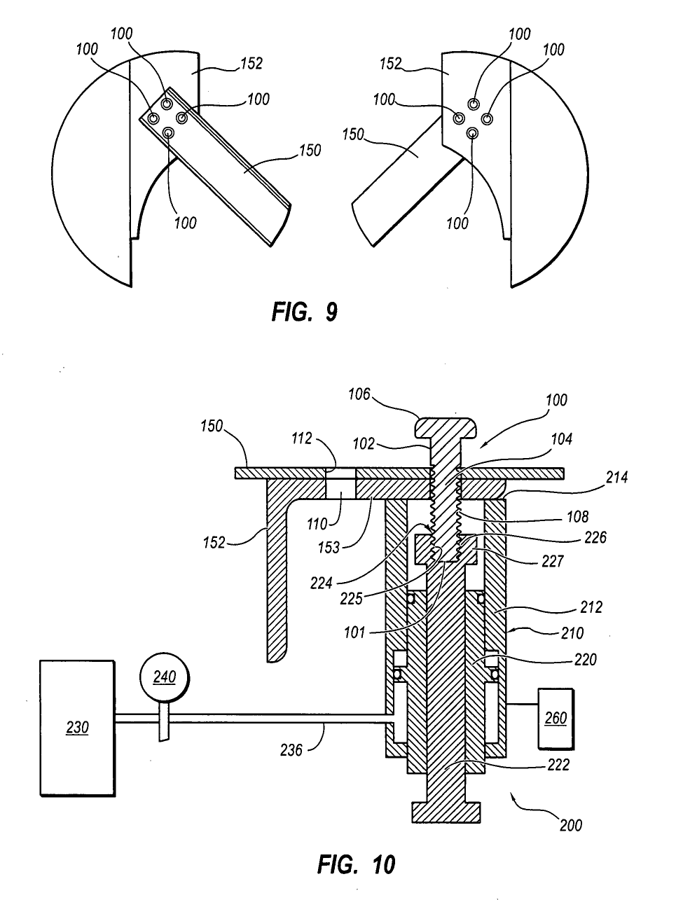

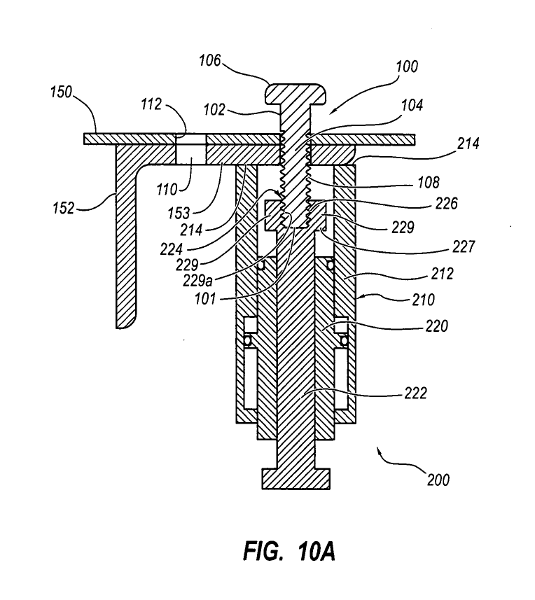

Referring now to FIGS. 9-11, in an exemplary embodiment of the present disclosure, there is a system and method for pushing or pulling the drive pin 100, discussed above, into an interference hole 110. Specifically referring to FIG. 10, the system 200 for pulling the pin 100 through an interference joint hole 110 formed between at least two adjacent structural members 150, 152 may include a hydraulic powered ram/piston device 210. It will be appreciated that while the pull system 200 and the push system 300 are both illustrated and disclosed as being hydraulic, it will be appreciated that other mechanisms, such as a pneumatic device, an electrical device or other mechanical or powered device or system that is known, or that may become known, in the art may be used without departing from the spirit or scope of the present disclosure.

The hydraulic ram/piston device 210 illustrated in FIG. 10 may be easily used by an operator due to its relative lightweight construction. Specifically, the ram device 210 may be less than about 20 pounds in weight, such that an operator can easily utilize the device 210 under less than optimal conditions and circumstances. The ram device 210 may include a piston 220 for moving the pin 100 into and through the hole 110. The piston 220 may include an interface rod 222 located at one end of the piston 220. The interface rod 222 may include a distal end portion 227 having a recess 224 defined by a sidewall 225. The sidewall 225 may include threads 226 for removably attaching the interface rod 222 to the threads 108 of a leading end 101 of the drive pin 100, which leading end may be located opposite the head 106, in threaded engagement. It will be appreciated that other attachment mechanisms may be used to attach the interface rod 222 to the leading end 101 of the pin, without departing from the spirit or scope of the present disclosure.

It will be appreciated that the interface rod 222 may be designed so that the distal end portion 227 may be threaded onto the threaded leading end 101 of the drive pin 100. The interface rod 222 may be directly threaded onto the drive pin 100 as illustrated in FIG. 10.

Alternatively, the interface rod 222, and particularly the distal end portion 227 of the interface rod 222, may be sectioned into a plurality of sections 229, which may be three sections for example as illustrated in FIG. 10A. The sections 229 can move in toward the drive pin 100 and out away from the drive pin 100 in a radial direction. As the plurality of sections 229 move toward and away from each other they have the ability to grasp and release the pin 100. Each of the plurality of sections 229 may include an inner surface 229a that may be threaded to match the threads 108 on the drive pin 100. The plurality of sections 229 of the interface rod 222 may then be brought toward each other and thereby toward the drive pin 100, creating a threaded chucked interface between the rod 222 and the drive pin 100. This would be similar to a chucked interface between a drill bit and a drill, except in the present embodiment the drill bit would be threaded and the chucked drill head would have mating threads for tightening down around the threads on the drill bit, thereby creating an interface that prevents the drill bit from pulling out of the chuck. This chucked locking interface between the rod 222 and the threaded shaft 104 of the drive pin 100 can be hydraulically driven by the same hydraulic pump 230 that the ram/piston device 210 uses or the motion of opening or closing the chuck end (distal end portion 227) of the interface rod 222 around the threaded shaft 104 of the drive pin 100 can be accomplished manually.

In either embodiment illustrated in FIGS. 10 and 10A, the distal end portion 227 of the interface rod 222 may be designed to be captured by the ram/piston 220. The distal end portion 227 of the rod 222 also has an attachment interface for a turning device to be applied to the opposite end of the rod for spinning the rod 222 down onto the threaded shaft 104 of the drive pin 100, if the chucked version of the rod 222 is not being used. Thus, it will be appreciated that the interface rod 222 can either be a separate part from the piston/ram 220, which is assembled through the body 212 of the piston, or, the interface rod 222 can be part of the piston/ram 220.

Once the interface rod 222 is threadedly engaged or otherwise attached to the pin 100 using another attachment mechanism, the piston or rod 220 may be activated, such that the pin 100 may be pulled through the interference hole 110 and into the installed position, as illustrated best in FIGS. 10 and 10A. Once a properly sized drive pin 100 has been pulled through the hole 110, the threads 226 of the interface rod 222 may be released from the threads 108 of the pin 100, thereby permitting removal of the rod 222 from the drive pin 100. Thereafter, the ram/piston system or device 210 may be removed from the area in which the drive pin 100 has been inserted into the hole 110, to permit assembly of the nut onto the drive pin 100. It will be appreciated that the assembly of the nut onto an end of the threaded shaft 104 of the drive pin 100 may be accomplished using any standard method that is known in the art.

It will be appreciated that the ram/piston device 210 may be powered by a hydraulic pump 230. A hydraulic line 236 may lead from the pump 230 to the piston 220 and may be regulated by a pressure or flow meter 240 so that a maximum allowable load can be set. This system allows for protection of the pins 100. If there is excessive interference between the drive pin 100 and the hole 110 then there is risk of damaging the pin 100.

To prevent the above scenario, the hydraulic system is pressure regulated to stop prior to a load being reached that is high enough to weaken the pin 100 or interference joint design. The regulation system may also include an indicator or sensor 260, which can be visual and/or audio, that notifies the operator if there was too little force or too much force used to pull the pin 100 into its installed position. The operator then can remove the pin 100 and create a joint that has sufficient interference by using a new pin 100 to properly fit the hole 110.

Thus, it will be appreciated that the device 210 may be equipped with a mechanical or electrical sensor 260 that may sense when: (i) there is too much mechanical clearance, i.e., when there is less than about 0.01 inch interference between the knurls 102 of the shank 104 of the pin 100 and the sidewall 112 of the hole 110; or (ii) there is too much mechanical stress, i.e., more than about 0.025 inch of interference between the knurls 102 of the shank 104 of the pin 100 and the sidewall 112 of the hole 110. When one or the other condition (i.e., (i) or (ii) above) is encountered, the sensor 260 may communicate either with the operator or even with the device 210 itself by sending a signal to the device 210 stopping the piston 220 from pulling the pin 100 through the hole 110 due to the sizing difficulties encountered between the diameter of the pin 100 and the diameter of the hole 110. The device 210 may, thus, provide a mechanism to maintain quality control and monitor the installation process to ensure proper fitting between the pin 100 and hole 110, whether through an audio and/or visual signal alerting the operator, or an electric or mechanical signal that may stop the device 210.

The powered ram/piston device 210 may include a body 212 that may be designed to allow the piston 220 enough room to travel in its natural direction. In an exemplary embodiment, the body 212 may allow for about one to about four inches of travel, and more specifically about two inches of travel, but this dimension could be more or less than the specified range, depending on the thickness of the structural members 150, 152 that the drive pin 100 is being pulled through, and/or the length of the drive pin 100 designed to be pulled through the interference hole 110. Thus, it will be appreciated that one of skill in the art can readily determine the proper travel distance for the piston 220 to travel in the body 212 using the above factors without departing from the spirit or scope of the present disclosure.

The body 212 of the powered ram/piston device 210 may include a lower section 214 that presses up against a near surface 153 of the structural member 152 through which the pin 100 may be pulled. This lower section 214 may be designed so that it distributes the reaction load from the piston 220 back down into the structural member 152. This lower section 214 may also be designed so that the interface rod 222 and the drive pin 100 do not come into contact or be obstructed in any way by the lower section 214 of the body 212 during the installation of the drive pin 100.

Further, the complete pulling system 200 can be set up to connect or attach to multiple drive pins 100 at the same time. In this embodiment, multiple drive pins 100 may be pulled through their respective interference connection joints or holes 110 simultaneously, thereby creating a faster, more efficient system.

A variation of the drive pin 100 may allow for a shortening of the threaded section of the shank 104 so that the threaded section does not have to project through the structural members 150, 152 prior to the interface rod 222 threading onto the pin shank 104, which is the method used when pulling the pin 100 through the interference hole 110. By reducing the drive pin shaft 104 diameter down almost M its normal diameter for the portion of the pin 100 that is threaded, the interface rod 222 can enter the interference hole 110 in the structural members 150, 152, and thread onto the drive pin shaft 104. In this embodiment, the drive pin shaft 104 is not required to have the threaded portion of the pin 100 be any longer than what is required for the nut to be applied in the final installed position of the pin 100.

If the reduction in diameter or the “step down” design on the drive pin 100 is not utilized, then the drive pin 100 must have a long enough threaded shaft 104 such that when the pin 100 is initially inserted through the interference holes 110 in the structural members 150, 152 the knurled 102, or ribbed, portion of the pin 100 may come into contact with a first surface of the structural members 150, 152. In this embodiment, the threaded shaft 104 of the drive pin 100 should extend past the surfaces of the structural members 150, 152 far enough for the interface rod 222 to thread onto the threaded drive pin shaft 104, or chuck onto the shaft 104.

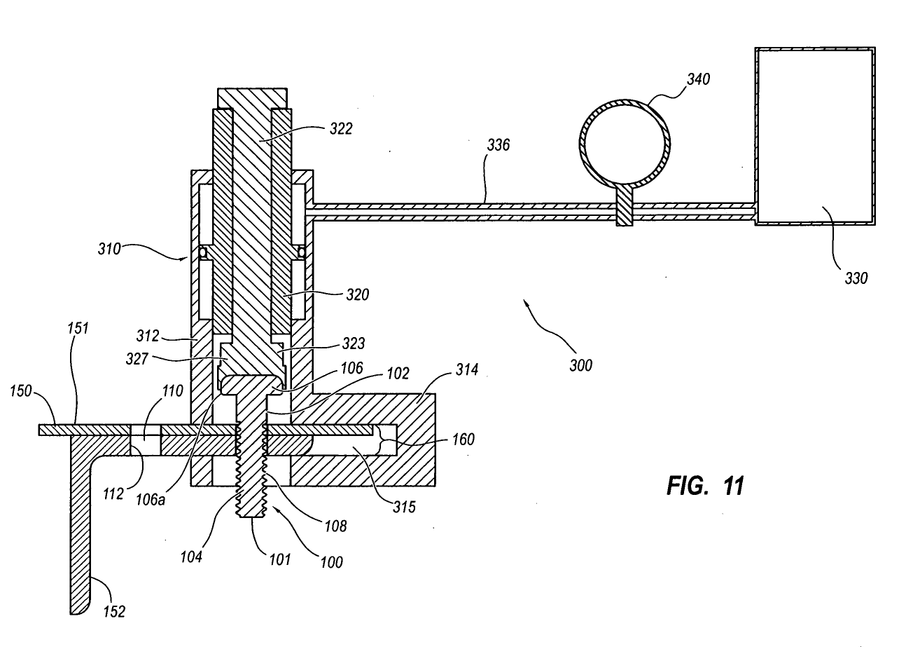

Referring now to FIG. 11, an alternative embodiment of a powered system, i.e., a pushing system 300, is illustrated. It will be appreciated that the pushing system 300 may have many similarities to the pulling system 200 (and method of pushing the drive pin 100) described above. The pushing system 300 may utilize the same or similar pump 330, pressure control 340, and monitoring capabilities as the pulling system 200. The two areas that differentiate the push system 300 from the pull system 200 include the main body 312 of the push system 300 and the interface rod 322.

With respect to the push system 300, the main body 312 may include an extension 314 with a recess 315 formed therein that may reach around the structural members 150, 152 to an opposite side 160 of the structural members 150, 152 being joined together. In this manner, the reaction load imparted by pushing the pin or pins 100 into the hole or holes 110 may be applied to the same surface and area that the pulling system 200 may apply to the reaction load.

The main body 312 of the push system 300 may further include an alignment feature that may align the body 312 substantially perpendicular to the structural members 150, 152. In this manner, the drive pin 100 may be axially aligned with respect to the interference holes 110 formed by joining the structural members 150, 152.

It will be appreciated that a head 323 may be formed on the distal end portion 327 of the interface rod 322 may be shaped to interface with the head 106 of the drive pin 100 for controlling further axial alignment. The head 323 may also be shaped so that the piston 320 or the interface rod 322 (depending upon the interface rod 322 is unitary or modular with respect to the piston 320) may not extend beyond a distal most end 106a of the drive pin head 106, thus allowing the drive pin head 106 to reach the final installed position and the distal end 106a of the head 106 to contact a top surface 151 of structural member 150.

As discussed above, the interface between the drive pin 100 and the push system 300 can also be created by the interface rod 322, which may be attached to the piston 320. This allows for easier maintenance or adjustability if different drive pin sizes 100 or head 106 shapes are to be used.

When two structural members 150, 152 are being joined through an interference fit connection with this system 300, the drive pin 100 may be inserted from the side so that the pin 100 may penetrate the thinnest structural member first (which in FIG. 11 is structural member 150) and lastly penetrating the thicker structural member (which in FIG. 11 is structural member 152).

Once the drive pin 100 is inserted correctly and completely the push system 300 or pull system 200 can be removed and the nuts (not illustrated) to the drive pins 100 may be assembled and tightened down onto the threads 108 of the shank 104. The tightening of the nuts onto the drive pins 100 may be done through a variety of methods common to the bolting industry and such methods fall within the scope of the present disclosure.

Those having ordinary skill in the relevant art will appreciate the advantages provided by the features of the present disclosure. For example, it is a potential feature of the present disclosure to provide a hydraulic, pneumatic, electric, or other powered system to either push or pull a pin through an interference joint or interference hole. It is another potential feature of the present disclosure to provide a system, independent of pushing or pulling, that may provide a method to monitor how much force may be used to insert the pin into the joint or joint hole. It is yet another potential feature of the present disclosure to provide a system and means for aligning and maintaining alignment of the pin to the hole.

In the foregoing Detailed Description of the Disclosure, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method of joining two structural members as part of a wind turbine structural tower, comprising the steps of:
providing a first structural member and a second structural member, wherein the first structural member comprises a first hole having a first sidewall defining a first diameter and the second structural member comprises a second hole having a second sidewall defining a second diameter;
providing a drive pin that comprises a plurality of knurls on an outer surface of the drive pin, wherein the outer knurled surface comprises a third diameter that is larger than the first diameter and the second diameter;
aligning the first hole with the second hole;
inserting the pin through the first hole and the second forming an interference fit.

2. A method of joining two structural members as part of a wind turbine structural tower, comprising the steps of:
providing a first structural member and a second structural member, wherein the first structural member comprises a first hole having a first sidewall defining a first diameter and the second structural member comprises a second hole having a second sidewall defining a second diameter;
providing a drive pin that comprises a plurality of knurls on an outer surface of the drive pin, wherein the outer knurled surface comprises a third diameter that is larger than the first diameter and the second diameter;
aligning the first hole with the second hole;
inserting the pin through the first hole and the second hole into a final position using a ram device.

3. The method of claim 2, wherein the method further includes providing the drive pin with a threaded distal section and further providing a threaded nut, and threading the nut onto the threaded distal section of the drive pin after said drive pin is located in its final position.

4. The method of claim 2, wherein the first diameter and the second diameter are substantially equal and the drive pin is inserted into the first hole and the second hole forming an interference fit between the first sidewall, the second sidewall and the knurls of the pin using a pulling system comprising the ram device.

5. The method of claim 4, wherein the pulling system is one of a hydraulic system, a pneumatic system, an electric system and a powered system.

6. The method of claim 2, wherein the method further comprises measuring for allowable tolerances between the third diameter of the drive pin and the first diameter of the first structural member and the second diameter of the second structural member as the drive pin is being inserted into its final position.

7. The method of claim 2, wherein the first diameter and the second diameter are substantially equal and wherein the drive pin is inserted into the first hole and the second hole forming an interference fit between the first sidewall, the second sidewall and the knurls of the pin using a pushing system comprising the ram device.

8. The method of claim 7, wherein the pulling system is one of a hydraulic system, a pneumatic system, an electric system and a powered system.

9. The method of claim 2, wherein the method further comprises monitoring pressure between the drive pin and the first hole and the second hole using a control monitoring device.

10. The method of claim 9, wherein the method further comprises signaling an operator if the pressure between the drive pin and the first hole and the second hole has not met or exceeded a minimum pressure, thereby notifying the operator when there is insufficient interference between the knurls of the outer surface of the drive pin and the first sidewall of the first hole and the second sidewall of the second hole to form an acceptable interference fit at the joint.

11. The method of claim 9, wherein the method further includes preventing installation of an improperly sized drive pin having a pressure value that is sufficient to cause damage to one of the drive pin and the joint formed between the first structural member and the second structural member using the control monitoring device.

12. The method of claim 9, wherein the method further comprises signaling an operator if the pressure between the drive pin and the first hole and the second hole has exceeded a maximum pressure, thereby notifying the operator when the interference between the knurls of the outer surface of the drive pin and the first sidewall of the first hole and the second sidewall of the second hole is too large to form an acceptable interference fit at the joint.

13. A system for joining two structural members as part of a wind turbine structural tower, comprising:
at least one joint formed by a first structural member that comprises a first sidewall defining a first hole having a first diameter and a second structural member that comprises a second sidewall defining a second hole with a second diameter, wherein the first hole and the second hole are alignable to form an interference hole;
at least one drive pin that comprises a head and an outer surface defining a shank with a plurality of knurls on the outer surface, wherein the outer knurled surface comprises a third diameter that is larger than the first diameter and the second diameter; and
a ram device that comprises an interface rod including an interface surface that engages a portion of the drive pin, such that when the ram device is actuated the interface rod moves the drive pin from a first uninstalled position to a second installed position within the joint forming an interference fit between the knurls of the drive pin and the first sidewall of the first hole and the second sidewall of the second hole, thereby joining the first structural member to the second structural member.

14. The system of claim 13, wherein the first diameter of the first hole and the second diameter of the second hole are substantially equal.

15. The system of claim 13, wherein the ram device is hydraulic and further comprises a hydraulic pump, a hydraulic pressure control device, monitoring means, signaling means, and a guide and alignment device.

16. The system of claim 13, wherein the shank of the drive pin comprises threads and wherein the interface surface comprises threads, wherein the interface surface threadedly engages the shank of the drive pin, such that when the interface rod is actuated by the ram device, the drive pin is pulled into the joint by the interface rod.

17. The system of claim 13, wherein the interface surface engages the head of the drive pin, such that when the interface rod is actuated by the ram device, the drive pin is pushed into the joint by the interface rod.

18. The system of claim 13, wherein a plurality of threaded sections are formed on a distal end portion of the interface rod creating a threaded chuck to interface with a threaded portion of the drive pin.

19. The system of claim 18, wherein the threaded chuck is manually opened and closed.

20. The system of claim 18, wherein the threaded chuck is operable via a hydraulic pump.

21. The system of claim 20, wherein the threaded chuck is controlled by an operator actuating the hydraulic pump, thereby causing the threaded sections to interface with the threaded portion of the drive pin and also causing the interface rod to actuate pulling the pin into the joint.

22. The system of claim 13, wherein the ram device is less than 20 pounds and is designed to be carried and operated by a single operator.

23. The system of claim 13, wherein ram device pulls the drive pin through the joint created by aligning the first hole with the second hole to create the interference fit between the knurls of the drive pin and the first sidewall and the second sidewall.

24. The system of claim 13, wherein ram device pushes the drive pin through the joint created by aligning the first hole with the second hole to create the interference fit between the knurls of the drive pin and the first sidewall and the second sidewall.

25. The system of claim 13, wherein the at least one drive pin comprises a plurality of drive pins that are insertable into a plurality of interference holes, wherein the ram device simultaneously moves the plurality of drive pins through the plurality of interference holes to create the interference fit.

26. A method of joining two structural members as part of a wind turbine structural tower, comprising the steps of:
providing a first structural member and a second structural member, wherein the first structural member comprises a first sidewall defining a first hole having a first diameter and the second structural member comprises a second sidewall defining a second hole having a second diameter;
providing a drive pin that comprises a plurality of knurls on an outer surface of the drive pin, wherein the outer knurled surface comprises a third diameter that is larger than the first diameter and the second diameter;
monitoring an interference fit between the knurls of the outer surface of the drive pin and the first sidewall of the first hole and the second sidewall of the second hole as the drive pin is being installed in a final position using a control monitoring device that is part of a ram device; and
providing feedback to an operator if certain joint properties are not achieved.

27. A method of joining two structural members as part of a wind turbine structural tower, comprising the steps of:
aligning a first structural member and a second structural member such that an interference hole having a first diameter is formed between the first structural member and the second structural member;
inserting a pin into the interference hole, wherein the pin comprises a second diameter that is larger than the first diameter;
pulling the pin into the interference hole using a pull system.

28. The method of claim 27, wherein the aligning step further includes aligning a first hole formed in the first structural member with a second hole formed in the second structural member, such that the aligning of the first hole and the second hole creates the interference hole.

29. The method of claim 27, wherein the pulling step comprises attaching a threaded section of an interface rod of the pull system to a threaded portion of the pin.

30. The method of claim 27, wherein the pulling step comprises attaching a hydraulic ram device to the pin and actuating the ram device to pull the pin into the interference hole.

31. A method of joining two structural members as part of a wind turbine structural tower, comprising the steps of:
aligning a first structural member and a second structural member such that an interference hole having a first diameter is formed between the first structural member and the second structural member;
inserting a pin into the interference hole, wherein the pin comprises a second diameter that is larger than the first diameter;
pushing the pin into the interference hole using a push system.

32. The method of claim 31, wherein the pushing step comprises attaching an interface rod of the push system to a head portion of the pin and actuating the ram device to push the pin into the interference hole.

33. The method of claim 31, wherein the pushing step comprises attaching a hydraulic ram device to the pin and actuating the ram device to push the pin into the interference hole.
